(19) United States
(12) Patent Application Publication
(10) Pub. No.: US 2025/0361146 A1
(43) Pub. Date: Nov. 27, 2025

(54) METHOD FOR SEPARATION, PURIFICATION AND REGENERATION OF SPENT LITHIUM IRON PHOSPHATE ELECTRODE MATERIALS

(71) Applicant: China University of Mining and Technology, Xuzhou (CN)

(72) Inventors: Guangwen Zhang, Xuzhou (CN); Xue Yuan, Xuzhou (CN); Tao Jiang, Xuzhou (CN); Chenlong Duan, Xuzhou (CN); Yaqun He, Xuzhou (CN)

(73) Assignee: China University of Mining and Technology, Xuzhou (CN)

(21) Appl. No.: 19/289,031

(22) Filed: Aug. 2, 2025

(30) Foreign Application Priority Data
Feb. 14, 2025 (CN) 202510166240.7

(51) Int. Cl. C01B 25/45; C01B 32/205

(52) U.S. Cl. CPC C01B 25/45; C01B 32/205; C01P 2006/40

(57) ABSTRACT

A method for separation, purification and regeneration of spent lithium iron phosphate electrode materials is disclosed, the present disclosure removes the anode material graphite by selective water dissolution and separation of the anode binder, and achieves the leaching of lithium ions in the graphite anode material and serves as a lithium supplement agent; the surface modification and activation of spent lithium iron phosphate cathode materials are performed by high purity oxygen low-temperature plasma ashing technology, while removing organic matter to achieve the dissociation of lithium iron phosphate particles, the surface carbon content of spent lithium iron phosphate electrode materials is effectively controlled to achieve the objective of deep purification and carbon removal, moreover, the internal crystal structure of the electrode material is activated, the migration channel of lithium ion is activated, and the subsequent lithium supplement efficiency is greatly improved.

### TECHNICAL FIELD

The present disclosure relates to the technical field of recycling spent lithium-ion batteries, and specifically relates to a method for separation, purification and regeneration of spent lithium iron phosphate electrode materials.

### BACKGROUND

With the rapid development of the electric vehicle industry in recent years, the amount of spent lithium-ion batteries commonly used in electric vehicle power batteries has also increased dramatically. If the spent lithium-ion batteries are not recycled properly, there can be a lot of environmental pollution issues, such as large amounts of solid waste landfills, heavy metal pollution, dust pollution, and water pollution, and additionally a waste of resources will be caused. Therefore, recycling of spent lithium-ion batteries can not only avoid environmental problems caused by solid waste accumulation, but also provide raw materials for the manufacture of new batteries, so as to improve resource utilization.

For the recycling of lithium iron phosphate electrode materials, the most economically viable recovery method is to use in-situ repair and regeneration technology, which converts spent electrode materials into recycled electrode materials that are highly conformant with a series of indicators of the electrochemical properties of industrial grade lithium iron phosphate electrode materials. The in-situ repair technology has extremely high requirements for the purity of electrode materials, particularly stringent requirements for carbon impurity content. Therefore, it is a critical step in the repair and regeneration of spent lithium iron phosphate electrode materials to separate and purify them, and perform deep removal of carbon impurities and surface activation on this basis.

Spent lithium iron phosphate electrode materials can be deeply purified and decarbonized through high-temperature aerobic roasting, but there are huge energy consumption issues during the high-temperature roasting process. Secondly, the electrode materials will be oxidized by aerobic roasting, resulting in changes to their internal crystal lattice and increasing the energy consumption of the subsequent in-situ repair process. In recent years, anaerobic pyrolysis has become a technical means to achieve efficient removal of organic matter from electrode materials, but the large amount of pyrolysis residue produced after anaerobic pyrolysis of organic matter blocks the migration pathways of lithium ions, leading to difficulties in lithium supplementation and repair of lithium iron phosphate.

### SUMMARY

The present disclosure provides a method for the separation, purification and regeneration of spent lithium iron phosphate electrode materials, which effectively solves a series of technical problems, such as the difficulty in separating cathode and anode materials, the high energy consumption of aerobic roasting, the internal lattice change caused by the oxidation of electrode materials, and the low efficiency of lithium supplementation caused by a large amount of carbon residue produced by anaerobic pyrolysis, also, it provides a novel method for deep purification and surface activation of spent lithium iron phosphate with low energy consumption and high impurity removal efficiency, wherein the purification, impurity removal and repair regeneration of the spent lithium iron phosphate electrode material are achieved under the premise of ensuring the stability of the internal crystal structure of the electrode material.

A first objective of the present disclosure is to provide a method for separation, purification and regeneration of spent lithium iron phosphate electrode materials, including the following steps:
obtaining a cathode and anode mixed electrode plate by shredding, pre-treating and sorting a spent lithium iron phosphate battery, immersing the cathode and anode mixed electrode plate in deionized water to dissolve a water-soluble organic binder in the anode electrode and extract lithium from the anode material, performing an ultrasonication to detach the anode material from a copper foil, achieving efficient dissociation between the anode material and the copper foil as well as between graphite electrode material particles, and obtaining the anode material, the copper foil and the cathode electrode plate by sieving.

The graphite is obtained by filtering and drying the anode material.

The cathode electrode plate and the copper foil are crushed and sieved to separate the cathode material from a current collector, thereby obtaining spent lithium iron phosphate cathode material.

The spent lithium iron phosphate cathode material is performed a plasma ashing treatment in an oxygen atmosphere at 140° C. to 150° C., the organic binder, fluorine and carbon impurities in the cathode material are removed and a surface activation is achieved, thereby obtaining the lithium iron phosphate electrode material with deep impurity removal and purification.

Lithium supplementation is performed on the lithium iron phosphate electrode material with deep impurity removal and purification in a reducing atmosphere to replenish lithium ions missing from the internal crystal structure, a lithium-supplemented electrode material is obtained, the lithium-supplemented electrode material is roasted in an inert atmosphere at 550° C. to 800° C. to achieve a material solidification and a crystal structure repair, thereby obtaining a regenerated lithium iron phosphate electrode material.

As a preferred embodiment, a solid-to-liquid ratio of the cathode and anode mixed electrode plates to deionized water is 100-150 g:1 L, with an immersion time of 45 min-75 min.

As a preferred embodiment, an ultrasonic frequency is 35 kHz-45 kHz, with an ultrasonic duration of 1 min-3 min.

As a preferred embodiment, a mesh size of the sieve used for sieving is greater than 2 mm and smaller than dimensions of the cathode electrode plate.

As a preferred embodiment, the mesh size of the sieve used for sieving is 0.075 mm.

As a preferred embodiment, the plasma ashing treatment is as follows: at 140° C.-150° C., a purity of 99.999% oxygen atmosphere with a flow rate of 0.15 L/min-0.2 L/min, a low-temperature plasma ashing instrument with power of 70 W-110 W, and vacuum of 3 mbar performs the plasma ashing treatment for 5 min-25 min.

As a preferred embodiment, after filtration of the anode material, a lithium-containing solution is further obtained, the lithium-containing solution serves as a lithium supplement agent, and a liquid lithium supplement solution is obtained with lithium carbonate or lithium sulfate as an external lithium source, and citric acid and ascorbic acid as a lithium supplementation media.

As a preferred embodiment, the lithium supplementation is as follows: the lithium iron phosphate electrode material with deep impurity removal and purification is mixed with the liquid lithium supplement solution at the solid-to-liquid ratio of 80 g-120 g:1 L, and reacted at 70° C.-90° C. for 5 h-7 h under normal pressure.

As a preferred embodiment, a lithium ion concentration in the liquid lithium supplement solution is 0.15 mol/L-0.2 mol/L, and a mass ratio of a lithium deficiency in the lithium iron phosphate electrode material with deep impurity removal and purification to a lithium content in the liquid lithium supplement solution is 1:1.05-1.2.

As a preferred embodiment, the roasting time is 2 h-3 h.

Compared with the existing technology, the beneficial effect of the present disclosure is as follows:

the present disclosure provides a method for separation, purification and regeneration of spent lithium iron phosphate electrode materials, the cathode and anode mixed electrode plates of spent lithium iron phosphate battery are subjected to water immersing-ultrasonic-sieving to achieve selective separation and removal of anode graphite, and the leaching of lithium ions in graphite is synchronously achieved; the decomposition and removal of organic matter, and deep impurity removal and surface modification of cathode material lithium iron phosphate are completed by low-temperature plasma ashing technology; the electrode materials after deep decarburization and purification achieve the in-situ repair and regeneration of the electrode materials by lithium supplementation and solidification roasting. The present disclosure achieves the synergy between the separation and removal of graphite and the selective extraction of lithium in graphite by the method of selective dissolution of organic binder; the method of low-temperature plasma ashing can not only achieve the efficient removal of organic matter in a short time, but also achieve the removal of carbon impurities, the blockage of lithium ion migration channel by residual carbon is avoided, and the objective of surface activation is achieved, which makes the process of lithium supplementation more convenient; the in-situ repair and regeneration of spent lithium iron phosphate electrode materials are achieved by the combination of liquid-phase lithium supplementation and solidification roasting, so as to obtain lithium iron phosphate electrode materials with better electrochemical properties.

In the later stage of liquid-phase lithium supplementation and solidification roasting, the lithium-containing solution obtained by filtering the anode material is used for liquid-phase lithium supplementation in the process of lithium supplementation, since the lithium-containing solution contains dissolved organic binder, it achieves carbon coating on the electrode material in the later stage of solidification roasting, thus further repairing the spent lithium iron phosphate electrode material and obtaining the lithium iron phosphate electrode material with better electrochemical properties.

### BRIEF DESCRIPTION OF THE DRAWINGS

FIG. 1 is a process flow diagram of a method for separation, purification and regeneration of spent lithium iron phosphate electrode materials of the present disclosure.

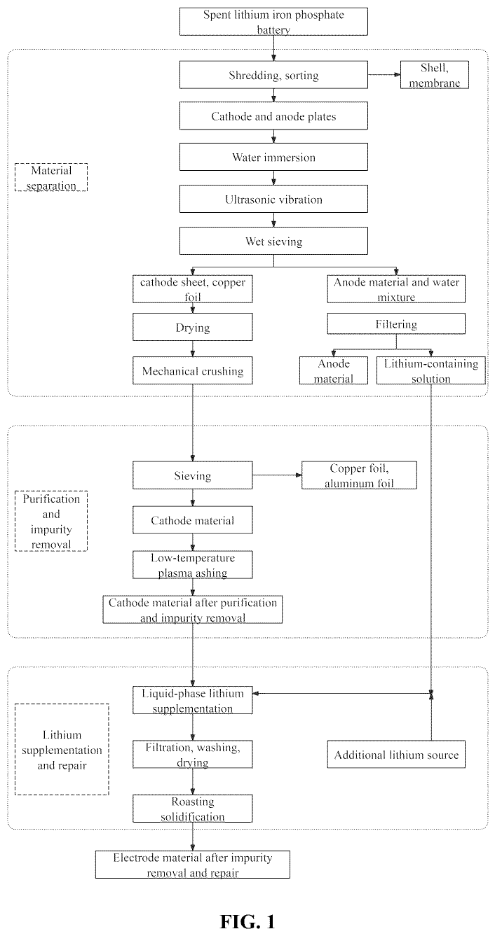

FIG. 2 is a comparison chart of a carbon content of cathode materials treated with different ashing times.

### DETAILED DESCRIPTION OF THE EMBODIMENTS

The following provides a further description of the present disclosure with reference to specific examples and accompanying drawings to better enable those skilled in the art to understand and implement the technical solutions of the present disclosure. However, the examples provided are not intended to limit the scope of the present disclosure. Unless otherwise specified, the experimental methods and detection methods described below are conventional methods; unless otherwise specified, the reagents and raw materials are commercially available.

According to the background technology of the present disclosure, firstly, it is difficult to separate the cathode and anode materials of the spent lithium iron phosphate battery; secondly, although the spent lithium iron phosphate electrode material can remove the organic matter of the electrode material after high-temperature aerobic roasting and anaerobic pyrolysis, there will be a large energy consumption problem in the high-temperature roasting process; thirdly, the aerobic roasting will oxidize the electrode material and change its internal lattice, the carbon residue of anaerobic pyrolysis will block the lithium supplement channel, resulting in low efficiency and increased energy consumption in the subsequent in-situ repair process, so the present disclosure provides a method for separation, purification and regeneration of spent lithium iron phosphate electrode materials.

The following is a detailed description of the technical solution of the present disclosure.

The present disclosure provides a method for separation, purification and regeneration of spent lithium iron phosphate electrode materials, including the following steps:

the cathode and anode mixed electrode plates are obtained by shredding the spent lithium iron phosphate battery and using the magnetic-electric-wind synergistic separation, the cathode and anode mixed electrode plates are immersed in deionized water to dissolve the water-soluble organic binder in the anode material, and the lithium element in the anode electrode graphite is extracted at the same time, the anode material is detached from the copper foil by ultrasonic vibration, and the efficient dissociation between the graphite anode material and the copper foil current collector as well as between the graphite electrode material particles is achieved, then, the large mesh size sieve is used to separate the anode electrode graphite from the copper foil and the cathode electrode plate.

The graphite and lithium-containing solution are obtained by filtering and drying the separated anode material, and the lithium-containing solution is used for the subsequent lithium supplementation and repair of the cathode material.

The cathode electrode plate and the copper foil are crushed together, and the crushed material is passed through a 0.075 mm mesh size sieve to separate the cathode material from the current collector, thereby obtaining spent lithium iron phosphate cathode material.

The spent lithium iron phosphate cathode material is performed the plasma ashing treatment in the oxygen atmosphere at 140° C. to 150° C., wherein the organic binder, fluorine and carbon impurities in the cathode material are removed and the surface activation is achieved, thereby obtaining the lithium iron phosphate electrode material with deep impurity removal and purification.

The liquid-phase lithium supplementation is performed on the lithium iron phosphate electrode material with deep impurity removal and purification in the reducing atmosphere to replenish lithium ions missing from the internal crystal structure, then the lithium-supplemented electrode material is obtained by performing the solid-liquid separation and washing the cathode material several times, and the lithium-supplemented electrode material is roasted in the inert atmosphere at 550° C. to 800° C. to achieve the material solidification and the crystal structure repair, thereby obtaining the regenerated lithium iron phosphate electrode material.

In the above technical scheme, the synergy between the separation and removal of graphite and the selective extraction of lithium in graphite is achieved by the method of selective dissolution of organic binder; the method of low-temperature plasma ashing can not only achieve the efficient removal of organic matter in a short time, but also achieve the removal of carbon impurities, the blockage of lithium ion migration channel by residual carbon is avoided, and the objective of surface activation is achieved, which makes the process of lithium supplementation more convenient; the in-situ repair and regeneration of spent lithium iron phosphate electrode materials are achieved by the combination of liquid-phase lithium supplementation and solidification roasting, so as to obtain lithium iron phosphate electrode materials with better electrochemical properties.

In order to effectively improve the dissolution efficiency of the organic binder in the anode material, the solid-liquid ratio of the cathode and anode mixed electrode plates to deionized water is 100-150 g:1 L, and the immersion time is 45 min-75 min, to avoid the short time, the binder of the anode material is not fully dissolved, leading to the low graphite removal efficiency, and to avoid the loss of lithium ions in the cathode material lithium iron phosphate due to excessive immersion time.

In order to improve the efficient stripping of the anode material graphite from the copper foil current collector, ultrasonic vibration is used to enhance the stripping efficiency and promote the dissociation between the graphite particles, the ultrasonic frequency is 35 kHz-45 kHz, with the ultrasonic duration of 1 min-3 min, the ultrasonic treatment uses sieving to achieve the removal of the enriched material graphite, the mesh size used to improve the sieving efficiency is greater than 2 mm but smaller than the dimensions of the cathode electrode plate.

In order to deeply purify and remove the organic matter and carbon impurities in the spent lithium iron phosphate electrode material, the low-temperature plasma ashing treatment is performed by low-temperature plasma ashing instrument, the plasma ashing treatment is as follows: at 140° C.-150° C., a purity of 99.999% oxygen atmosphere with the flow rate of 0.15 L/min-0.2 L/min, the low-temperature plasma ashing instrument with power of 70 W-110 W, and vacuum of 3 mbar performs the plasma ashing treatment for 5 min-25 min.

In order to achieve the separation of lithium iron phosphate electrode material and current collector, the sample after ashing treatment was sieved, the sieving is performed by sieve mesh, and the mesh size of the sieve mesh is 0.075 mm.

In order to perform liquid-phase lithium supplementation on the lithium iron phosphate electrode material with deep impurity removal and purification, after filtration of the anode material, the lithium-containing solution is further obtained, the lithium-containing solution serves as the lithium supplement agent, and the liquid lithium supplement solution is obtained with lithium carbonate or lithium sulfate as the external lithium source, and citric acid and ascorbic acid as the lithium supplementation media.

In order to effectively replenish the loss of lithium ions in the internal crystal structure of the purified electrode material, the lithium supplement is as follows: the lithium iron phosphate electrode material with deep impurity removal and purification is mixed with the liquid lithium supplement solution at the solid-to-liquid ratio of 80 g-120 g:1 L, and reacted at 70° C.-90° C. for 5 h-7 h under the normal pressure.

In order to improve the reduction efficiency of iron in spent lithium iron phosphate and promote lithium supplementation, the lithium ion concentration in the liquid lithium supplement solution is 0.15 mol/L-0.2 mol/L, and the mass ratio of the lithium deficiency in the lithium iron phosphate electrode material with deep impurity removal and purification to the lithium content in the liquid lithium supplement solution is 1:1.05-1.2.

To further achieve optimal lithium supplementation, the electrode material after liquid-phase lithium supplementation is roasted in the inert atmosphere at 550° C.-800° C. to achieve material solidification and crystal structure repair, thereby obtaining regenerated lithium iron phosphate electrode material, the roasting time is 2 h-3 h, which achieves sufficient lithium ion embedding while saving energy consumption and avoiding insufficient solidification due to too short roasting time and serious energy consumption waste due to too long roasting time.

The following provides a detailed description of the technical effects of the present disclosure through specific examples and comparative examples.

### Example 1

a method for separation, purification and regeneration of spent lithium iron phosphate electrode materials, including the following steps:
S1, the cathode and anode mixed electrode plates are obtained by shredding, pre-treating and sorting the spent lithium iron phosphate battery, according to the solid-liquid ratio of 100 g:1 L, the cathode and anode mixed electrode plates are immersed in deionized water for 60 min to dissolve the water-soluble organic binder in the anode material, the anode material is detached from the copper foil by ultrasonic vibration at 40 KHz frequency for 1 min, so as to achieve the efficient dissociation between the graphite anode material and the copper foil current collector as well as between the graphite electrode material particles, then, the large mesh size sieve is used to separate the graphite from the copper foil and the cathode electrode plate.
S2, the graphite and lithium-containing solution are obtained by filtering and drying the separated anode material, the lithium-containing solution is used for the subsequent lithium supplementation and repair of the cathode material.
S3, the separated cathode electrode plate and the copper foil are crushed together, and the crushed material is passed through the 0.075 mm mesh size sieve to separate the cathode material from the current collector, thereby obtaining spent lithium iron phosphate cathode material.
S4, the cathode material obtained by the separation is subjected to plasma ashing by the low-temperature plasma ashing instrument with power of 100 W and the vacuum of 3 mbar for 15 min at 145° C., the purity of 99.999% oxygen atmosphere with the flow rate of 0.2 L/min, the organic binder, fluorine and carbon impurities in the cathode material are removed and the surface activation is achieved, thereby obtaining the lithium iron phosphate electrode material with deep impurity removal and purification.
S5, according to the solid-liquid ratio of 100 g:1 L, the lithium iron phosphate electrode material with deep impurity removal and purification is placed in a reducing atmosphere, and the liquid lithium supplement agent with a lithium ion concentration of 1.05 mol/L is used for liquid-phase lithium supplementation, the lithium-containing solution obtained by filtration of the anode material is used as the lithium supplement agent, lithium carbonate is used as the external lithium source, and citric acid and ascorbic acid are used as the lithium supplement medium, the molar ratio of the lithium deficiency amount of the lithium iron phosphate electrode material with deep impurity removal and purification to the lithium content of the liquid lithium supplement agent is 1:1.05, and the reaction is performed at 80° C. for 6 h under the normal pressure, the lithium ion missing from the internal crystal structure is replenished, then the solid-liquid separation is performed and the cathode material is washed several times, then the The liquid phase lithium-supplemented electrode material is roasted in the inert atmosphere at 600° C. for 2.0 h to achieve the material solidification and the crystal structure repair, thereby obtaining the regenerated lithium iron phosphate electrode material.

### Example 2

a method for separation, purification and regeneration of spent lithium iron phosphate electrode materials, including the following steps:
S1, the cathode and anode mixed electrode plates are obtained by shredding, pre-treating and sorting the spent lithium iron phosphate battery, according to the solid-liquid ratio of 150 g:1 L, the cathode and anode mixed electrode plates are immersed in deionized water for 45 min to dissolve the water-soluble organic binder in the anode material, the anode material is detached from the copper foil by ultrasonic vibration at 35 KHz frequency for 2 min, so as to achieve the efficient dissociation between the graphite anode material and the copper foil current collector as well as between the graphite electrode material particles, then, the large mesh size sieve is used to separate the graphite from the copper foil and the cathode electrode plate.
S2, the graphite and lithium-containing solution are obtained by filtering and drying the separated anode material, the lithium-containing solution is used for the subsequent lithium supplementation and repair of the cathode material.
S3, the separated cathode electrode plate and the copper foil are crushed together, and the crushed material is passed through the 0.075 mm mesh size sieve to separate the cathode material from the current collector, thereby obtaining spent lithium iron phosphate cathode material.
S4, the cathode material obtained by the separation is subjected to plasma ashing by the low-temperature plasma ashing instrument with power of 70 W and the vacuum of 3 mbar for 5 min at 140° C., the purity of 99.999% oxygen atmosphere with the flow rate of 0.15 L/min, the organic binder, fluorine and carbon impurities in the cathode material are removed and the surface activation is achieved, thereby obtaining the lithium iron phosphate electrode material with deep impurity removal and purification.
S5, according to the solid-liquid ratio of 100 g:1 L, the lithium iron phosphate electrode material with deep impurity removal and purification is placed in a reducing atmosphere, and the liquid lithium supplement agent with a lithium ion concentration of 1.2 mol/L is used for liquid-phase lithium supplementation, the lithium-containing solution obtained by filtration of the anode material is used as the lithium supplement agent, lithium carbonate is used as the external lithium source, and citric acid and ascorbic acid are used as the lithium supplement medium, the molar ratio of the lithium deficiency amount of the lithium iron phosphate electrode material with deep impurity removal and purification to the lithium content of the liquid lithium supplement agent is 1:1.2, and the reaction is performed at 80° C. for 6 h under the normal pressure, the lithium ion missing from the internal crystal structure is replenished, then the solid-liquid separation is performed and the cathode material is washed several times, then the The liquid phase lithium-supplemented electrode material is roasted in the inert atmosphere at 550° C. for 2.0 h to achieve the material solidification and the crystal structure repair, thereby obtaining the regenerated lithium iron phosphate electrode material.

### Example 3

a method for separation, purification and regeneration of spent lithium iron phosphate electrode materials, including the following steps:
S1, the cathode and anode mixed electrode plates are obtained by shredding, pre-treating and sorting the spent lithium iron phosphate battery, according to the solid-liquid ratio of 120 g:1 L, the cathode and anode mixed electrode plates are immersed in deionized water for 75 min to dissolve the water-soluble organic binder in the anode material, the anode material is detached from the copper foil by ultrasonic vibration at 45 KHz frequency for 3 min, so as to achieve the efficient dissociation between the graphite anode material and the copper foil current collector as well as between the graphite electrode material particles, then, the large mesh size sieve is used to separate the graphite from the copper foil and the cathode electrode plate.
S2, the graphite and lithium-containing solution are obtained by filtering and drying the separated anode material, the lithium-containing solution is used for the subsequent lithium supplementation and repair of the cathode material.
S3, the separated cathode electrode plate and the copper foil are crushed together, and the crushed material is passed through the 0.075 mm mesh size sieve to separate the cathode material from the current collector, thereby obtaining spent lithium iron phosphate cathode material.
S4, the cathode material obtained by the separation is subjected to plasma ashing by the low-temperature plasma ashing instrument with power of 100 W and the vacuum of 3 mbar for 25 min at 150° C., the purity of 99.999% oxygen atmosphere with the flow rate of 0.2 L/min, the organic binder, fluorine and carbon impurities in the cathode material are removed and the surface activation is achieved, thereby obtaining the lithium iron phosphate electrode material with deep impurity removal and purification.
S5, according to the solid-liquid ratio of 100 g:1 L, the lithium iron phosphate electrode material with deep impurity removal and purification is placed in a reducing atmosphere, and the liquid lithium supplement agent with a lithium ion concentration of 1.1 mol/L is used for liquid-phase lithium supplementation, the lithium-containing solution obtained by filtration of the anode material is used as the lithium supplement agent, lithium carbonate is used as the external lithium source, and citric acid and ascorbic acid are used as the lithium supplement medium, the molar ratio of the lithium deficiency amount of the lithium iron phosphate electrode material with deep impurity removal and purification to the lithium content of the liquid lithium supplement agent is 1:1.1, and the reaction is performed at 80° C. for 6 h under the normal pressure, the lithium ion missing from the internal crystal structure is replenished, then the solid-liquid separation is performed and the cathode material is washed several times, then the The liquid phase lithium-supplemented electrode material is roasted in the inert atmosphere at 800° C. for 3.0 h to achieve the material solidification and the crystal structure repair, thereby obtaining the regenerated lithium iron phosphate electrode material.

### Example 4

a method for separation, purification and regeneration of spent lithium iron phosphate electrode materials, including the following steps:
S1, the cathode and anode mixed electrode plates are obtained by shredding, pre-treating and sorting the spent lithium iron phosphate battery, according to the solid-liquid ratio of 130 g:1 L, the cathode and anode mixed electrode plates are immersed in deionized water for 50 min to dissolve the water-soluble organic binder in the anode material, the anode material is detached from the copper foil by ultrasonic vibration at 38 KHz frequency for 3 min, so as to achieve the efficient dissociation between the graphite anode material and the copper foil current collector as well as between the graphite electrode material particles, then, the large mesh size sieve is used to separate the graphite from the copper foil and the cathode electrode plate.
S2, the graphite and lithium-containing solution are obtained by filtering and drying the separated anode material, the lithium-containing solution is used for the subsequent lithium supplementation and repair of the cathode material.
S3, the separated cathode electrode plate and the copper foil are crushed together, and the crushed material is passed through the 0.075 mm mesh size sieve to separate the cathode material from the current collector, thereby obtaining spent lithium iron phosphate cathode material.
S4, the cathode material obtained by the separation is subjected to plasma ashing by the low-temperature plasma ashing instrument with power of 100 W and the vacuum of 3 mbar for 10 min at 148° C., the purity of 99.999% oxygen atmosphere with the flow rate of 0.18 L/min, the organic binder, fluorine and carbon impurities in the cathode material are removed and the surface activation is achieved, thereby obtaining the lithium iron phosphate electrode material with deep impurity removal and purification.
S5, according to the solid-liquid ratio of 100 g:1 L, the lithium iron phosphate electrode material with deep impurity removal and purification is placed in a reducing atmosphere, and the liquid lithium supplement agent with a lithium ion concentration of 1.05 mol/L is used for liquid-phase lithium supplementation, the lithium-containing solution obtained by filtration of the anode material is used as the lithium supplement agent, lithium carbonate is used as the external lithium source, and citric acid and ascorbic acid are used as the lithium supplement medium, the molar ratio of the lithium deficiency amount of the lithium iron phosphate electrode material with deep impurity removal and purification to the lithium content of the liquid lithium supplement agent is 1:1.15, and the reaction is performed at 80° C. for 6 h under the normal pressure, the lithium ion missing from the internal crystal structure is replenished, then the solid-liquid separation is performed and the cathode material is washed several times, then the The liquid phase lithium-supplemented electrode material is roasted in the inert atmosphere at 700° C. for 2.5 h to achieve the material solidification and the crystal structure repair, thereby obtaining the regenerated lithium iron phosphate electrode material.

In order to further explain the technical effects of the present disclosure, the present disclosure also provides comparative examples as follows:

### Comparative Example 1

Compared with example 1, the difference is that conventional aerobic roasting is used.

The spent lithium iron phosphate battery cathode electrode plate is roasted at 450° C. for 60 min under aerobic conditions, so that the organic binder in the electrode plate reacts with oxygen and is directly converted into CO₂ gas to achieve the objective of removing the organic binder, after recovering to room temperature, the electrode material is stripped on the current collector, then the electrode material is ball milled and sieved, and then roasted at 800° C. for 120 min under aerobic conditions to ensure that the polyvinylidene fluoride (PVDF), conductive carbon and carbon coating layer on the surface of the electrode material are completely removed; after recovering to room temperature, the electrode material without carbon impurities can be obtained. The decarbonized electrode material is fully mixed with the lithium supplement agent and placed in a hydrogen+argon gas atmosphere, after roasting at 350° C. for 5.0 h, it is heated to 650° C. for 10.0 h, and after roasting, it is restored to room temperature to obtain the repaired lithium iron phosphate electrode materials.

### Comparative Example 2

Compared with example 1, the difference is that conventional anaerobic pyrolysis of organic matter is used.

The spent lithium iron phosphate cathode material is roasted at 500° C. for 1.0 h in a nitrogen atmosphere to decompose the organic binder in the cathode material, and then the cathode material is detached on the aluminum foil, the detached cathode material is ball milled at a speed of 300 r/min for 2.0 h to ensure the full dissociation of the cathode material. After mixing the cathode material with the liquid-phase lithium supplement agent, the mixture is stirred in a water bath at 80° C. for 6.0 h, after solid-liquid separation, the cathode material is fully rinsed and dried in a vacuum drying oven for 24 h. Subsequently, the amount of lithium deficiency of the cathode material after liquid-phase lithium supplementation is determined by digestion, and lithium carbonate is added at 1.05 times the amount of lithium deficiency to fully grind and mix with the cathode material, and then roasted at 600° C. under nitrogen atmosphere for 2.0 h to complete the solid-phase lithium supplementation repair.

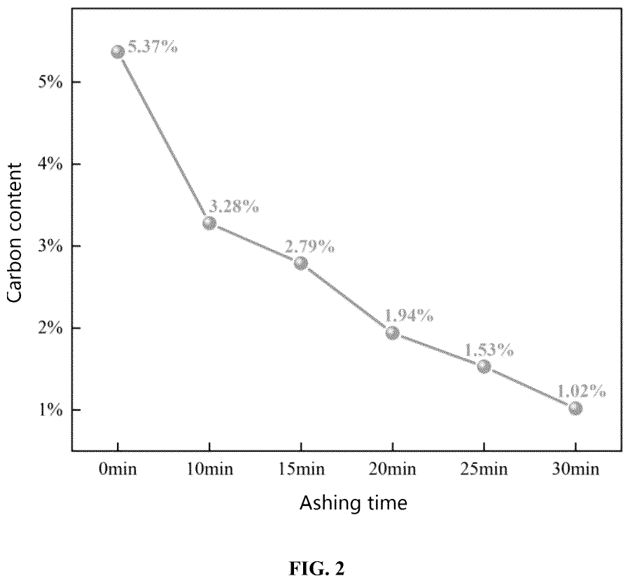

The method for removing the impurity carbon from the spent lithium iron phosphate electrode material provided by the above examples greatly improves the carbon removal efficiency, and reduces the energy consumption of carbon removal, and the in-situ repair and regeneration effect is good. In the example 1, according to the adhesion characteristics of the cathode and anode materials, the separation of the cathode and anode materials is achieved by hydraulic immersion, and the surface carbon removal is achieved by low-temperature plasma ashing heat treatment, which not only reduces the energy consumption, but also prevents the oxidation of the electrode material by aerobic roasting, also, the removal of the organic binder is ensured, so that the electrode material can be stripped off on the current collector smoothly; the carbon impurities in the electrode material can be effectively removed by controlling the low-temperature plasma ashing process, as shown in FIG. 2, it not only ensures the carbon removal efficiency, but also avoids the problem of high energy consumption of high-temperature aerobic roasting, meanwhile, the low-temperature plasma ashing process activates the internal crystal structure of the electrode material, which has a beneficial effect on the subsequent lithium supplementation.

In the example of the present disclosure, the separation result of the cathode and anode materials is that the purity of the cathode material is higher than 99.5%; the carbon content of the cathode material after low-temperature plasma ashing is reduced from 5.37% without ashing to 2.79% after ashing for 15 min; the ratio of Li:Fe:P in the cathode material after lithium repair increased from 0.89:1:1 without lithium repair to approximately 1:1:1, as shown in Table 1. Under the same lithium supplement conditions, the charge specific capacity of the lithium iron phosphate electrode material obtained in the present disclosure reaches 149.51 mAh/g, as shown in Table 2, the property is significantly better than that of the lithium iron phosphate electrode material obtained by the conventional technical process in the comparative examples.

TABLE 1
Elemental proportions in the cathode material before and after
lithium supplementation in Example 1 of the present disclosure

| | Li:Fe:P |
|---|---|
| Before lithium supplementation | 0.89:1:1 |
| After lithium supplementation | 1:1:1 |

TABLE 2
Comparison table of charge-discharge specific capacity
after repair of lithium iron phosphate in example 1 and
comparative examples 1-2 of the present disclosure

| | Charge specific capacity | |
|---|---|---|
| Example 1 | 149.51 | mAh/g |
| Comparative example 1 | 91.93 | mAh/g |
| Comparative example 2 | 95.55 | mAh/g |

In summary, through the method for separation, purification and regeneration of spent lithium iron phosphate electrode materials of the examples of the present disclosure, the free carbon in the spent lithium iron phosphate electrode material is efficiently removed and the coated carbon is retained, and the regeneration and repair effect is good, meanwhile, the stability of the electrode material lattice is ensured and the energy consumption is reduced.

Obviously, those skilled in the art can make various modifications and variations to the present disclosure without departing from the spirit and scope thereof. Thus, if such modifications and variations fall within the scope of the claims and their equivalents, the present disclosure also intends to include such modifications and variations.

What is claimed is:

1. A method for separation, purification and regeneration of spent lithium iron phosphate electrode materials, comprising the following steps:
obtaining a cathode and anode mixed electrode plate by shredding, pre-treating and sorting a spent lithium iron phosphate battery, immersing the cathode and anode mixed electrode plate in deionized water to dissolve a water-soluble organic binder in the anode electrode and extract lithium from the anode material, performing an ultrasonication to detach the anode material from a copper foil, thus achieving dissociation between the anode material and the copper foil as well as between graphite electrode material particles, and obtaining the anode material, the copper foil and the cathode electrode plate by sieving;
obtaining graphite by filtering and drying the anode material;
crushing and sieving the cathode electrode plate and the copper foil to separate the cathode material from a current collector, thereby obtaining spent lithium iron phosphate cathode material;
performing a plasma ashing treatment on the spent lithium iron phosphate cathode material in an oxygen atmosphere at 140° C. to 150° C., removing the organic binder, fluorine and carbon impurities in the cathode material, and achieving a surface activation, thereby obtaining the lithium iron phosphate electrode material with deep impurity removal and purification; and
performing a lithium supplementation on the lithium iron phosphate electrode material with deep impurity removal and purification in a reducing atmosphere to replenish lithium ions missing from an internal crystal structure, obtaining a lithium-supplemented electrode material, roasting the lithium-supplemented electrode material in an inert atmosphere at 550° C. to 800° C. to achieve a material solidification and a crystal structure repair, thereby obtaining a regenerated lithium iron phosphate electrode material.

2. The method for separation, purification and regeneration of spent lithium iron phosphate electrode materials according to claim 1, wherein after filtration of the anode material, a lithium-containing solution is further obtained, wherein the lithium-containing solution serves as a lithium supplement agent, and wherein a liquid lithium supplement solution is obtained with lithium carbonate or lithium sulfate as an external lithium source, and citric acid and ascorbic acid as a lithium supplementation media.

3. The method for separation, purification and regeneration of spent lithium iron phosphate electrode materials according to claim 2, wherein the lithium supplementation is as follows: the lithium iron phosphate electrode material with deep impurity removal and purification is mixed with the liquid lithium supplement solution at a solid-to-liquid ratio of 80-120 g:1 L, and reacted at 70-90° C. for 5 h-7 h under normal pressure.

4. The method for separation, purification and regeneration of spent lithium iron phosphate electrode materials according to claim 3, wherein a lithium ion concentration in the liquid lithium supplement solution is 0.15-0.2 mol/L, and a mass ratio of a lithium deficiency in the lithium iron phosphate electrode material with deep impurity removal and purification to a lithium content in the liquid lithium supplement solution is 1:1.05-1.2.

5. The method for separation, purification and regeneration of spent lithium iron phosphate electrode materials according to claim 1, wherein a solid-to-liquid ratio of the cathode and anode mixed electrode plates to deionized water is 100-150 g:1 L, with an immersion time of 45-75 min.

6. The method for separation, purification and regeneration of spent lithium iron phosphate electrode materials according to claim 1, wherein an ultrasonic frequency is 35-45 kHz, with an ultrasonic duration of 1-3 min.

7. The method for separation, purification and regeneration of spent lithium iron phosphate electrode materials according to claim 1, wherein a mesh size of the sieve used for sieving is greater than 2 mm and smaller than dimensions of the cathode electrode plate.

8. The method for separation, purification and regeneration of spent lithium iron phosphate electrode materials according to claim 1, wherein the mesh size of the sieve used for sieving is 0.075 mm.

9. The method for separation, purification and regeneration of spent lithium iron phosphate electrode materials according to claim 1, wherein the plasma ashing treatment is as follows: at 140-150° C., a purity of 99.999% oxygen atmosphere with a flow rate of 0.15-0.2 L/min, a low-temperature plasma ashing instrument with power of 70-110 W, and vacuum of 3 mbar performs the plasma ashing treatment for 5-25 min.

10. The method for separation, purification and regeneration of spent lithium iron phosphate electrode materials according to claim 1, wherein a roasting time is 2-3 h.
